(19) United States
(12) Patent Application Publication
(10) Pub. No.: US 2016/0159996 A1
(43) Pub. Date: Jun. 9, 2016

(54) HEAT-SEALABLE POLYOLEFIN FILMS AND SHEETS

(71) Applicant: BASELL POLIOLEFINE ITALIA S.R.L., Milano (IT)

(72) Inventors: ANTONELLA ANGELINI, FERRARA (IT); ANDREA FELISATI, FERRARA (IT); ROBERTA MARZOLLA, FERRARA (IT); ANDREAS NEUMANN, FERRARA (IT)

(73) Assignee: BASELL POLYOLEFINE ITALIA S.R.L., MILANO (IT)

(21) Appl. No.: 14/906,873

(22) PCT Filed: Jul. 1, 2014
(86) PCT No.: PCT/EP2014/063898

§ 371 Date: Jan. 21, 2016

(30) Foreign Application Priority Data
Jul. 22, 2013 (EP) 13177364.0

(51) Int. Cl. C08J 5/18; C08L 23/10

(52) U.S. Cl. CPC C08J 5/18; C08L 23/10; C08J 2323/10; C08J 2423/16; C08L 2205/02; C08L 2207/02; C08L 2203/162

(57) ABSTRACT

The present technology relates to films or sheets comprising a layer of a heterophasic propylene copolymer containing up to 7.0% by weight of ethylene-derived units and comprising: (a) 80%-92% by weight of a matrix phase comprising a propylene homopolymer or a propylene copolymer containing up to 5% by weight of units derived from ethylene and/or an alpha-olefin; and (b) 8%-20% by weight of a rubber phase comprising an ethylene-propylene copolymer containing 20%-60% by weight of ethylene-derived units.

The present disclosure relates to heat-sealable polyolefin films and sheets. Heat-sealable cast and blown polyolefin films are widely used in the packaging field, including for food packaging, but also for the packaging of other products and for the production of non-packaging items.

Packaging examples are the primary packaging of hygienic items, textile articles, magazines, mailing films, secondary collation packaging, shrink packaging films and sleeves, stretch packaging films and sleeves, form-fill-seal packaging films for portioning various types of articles such as bags, pouches or sachets, and vacuum formed blisters. Examples of form-fill-seal applications are the packaging of peat and turf, chemicals, plastic resins, mineral products, food products, and small size solid articles. The above applications involve the use of plastic films for packaging and are included in the general definition of “flexible plastic packaging”.

Non-packaging items are, for example, synthetic clothing articles or medical and surgical films, films which are formed into flexible conveying pipes, membranes for isolation and protection in soil, building and construction applications, and films which are laminated with non-woven membranes.

The film is characterized by the presence of at least one polyolefin layer that can be easily sealed to itself or to other materials by applying heat and pressure (a heat-sealable layer). The features of the seal, such as the seal strength, are determined by the choice and the relative amounts of the olefin polymers composing the sealing layer.

A type of food packaging that has gained great popularity is retort packaging. Such packaging results from multiple layers of flexible laminate that are used to create packaging containers such as pouches that, once the food is sealed into, allow for thermal processing for sterilization and/or bacterial population reduction.

Polymer products made up of heterophasic mixtures of propylene crystalline polymers and elastomeric olefin copolymers, which may be obtained by sequential stereospecific polymerization, are establishing themselves in the polypropylene industry. These products possess a beneficial blend of elastic properties and mechanical resistance and can easily be transformed into manufactured articles by using the equipment and processes normally used for thermoplastic materials. As disclosed in EP Pat. Doc. 0477662, such polymer products can be used to produce films with improved elongation at break and Elmendorf tear properties and good optical properties.

It is known in the art that deterioration of seal strength, optical and impact properties is observed after retorting. Thus, there is a need for polyolefin compositions suitable for film layers having good heat sealability and seal strength after retorting.

### SUMMARY OF THE INVENTION

It has now surprisingly been found that, by using specific heterophasic propylene copolymers, films exhibiting good seal properties, including good seal strength, after retorting can be produced. Those heterophasic copolymers are suitable to be used as sealing (outermost) layers in a heat-sealing film that can be subject to retorting.

Therefore, an object of the present technology is a film or sheet comprising at least one layer comprising a heterophasic propylene copolymer comprising:
(a) from 85% to 92% by weight of a matrix phase being a propylene homopolymer or a propylene copolymer containing up to 5% by weight of units derived from ethylene and/or an alpha-olefin; and
(b) from 8% to 15% by weight of a rubber phase that is an ethylene-propylene copolymer containing from 40% to 60% by weight of ethylene-derived units;
wherein the overall amount of component (a) and of component (b) is 100% by weight, and
wherein the heterophasic propylene copolymer contains up to 6.0% by weight of ethylene-derived units.

Suitably, the amount of rubber phase is lower than 14%, such as 13% by weight.

In some embodiments, the matrix phase (a) is a propylene homopolymer. When the matrix phase (a) is a copolymer of propylene, the amount of units derived from ethylene and/or from an alpha-olefin is, in certain embodiments, lower than 3%, such as lower than 2% by weight. Alpha-olefins that may be present as comonomers in the matrix phase (a) are represented by the formula CH2═CHR, wherein R is an alkyl radical, linear or branched, with 2-8 carbon atoms or an aryl, such as a phenyl or a radical. Examples of alpha-olefins for use in the present technology are 1-butene, 1-pentene, 1-hexene, 4-methyl-1-pentene and 1-octene.

According to an embodiment, the heterophasic propylene copolymer comprises:
(a2) from 85% to 92% by weight of a matrix phase being a propylene homopolymer or a propylene copolymer containing up to 5% by weight of units derived from ethylene and/or an alpha-olefin; and
(b2) from 8% to 15% by weight of a rubber phase that is an ethylene-propylene copolymer containing from 40% to 50% by weight of ethylene-derived units.

The heterophasic propylene copolymer for use in a film of the present technology may comprise, in certain embodiments:
a value of melt flow rate “L” (230° C., 2.16 Kg), for both components (a) and (b) as well as for the final heterophasic copolymer, of from 0.4 to 1.5 g/10 min, such as from 0.5 to 1.0 g/10 min;
a melting temperature (Tₘ) equal to or higher than 150° C., including higher than 155° C. and higher than 160° C.;
a fraction soluble in xylene at room temperature for the matrix (a) (XSa) equal to or less than 3.0% by weight, such as less than 2.5% by weight;
a fraction soluble in xylene at room temperature for the heterophasic copolymer (XS) equal to or less than 20.0% by weight, including less than 18.0% by weight;
a value of the intrinsic viscosity of the total (for the heterophasic copolymer) fraction soluble in xylene at room temperature (XSIV) of from 1.0 to 4.0, including from 2.0 to 3.5 and from 2.5 to 3.0 dl/g.

The heterophasic propylene copolymer for use in a film of the present disclosure may be produced by sequential polymerization (reactor blend). In some embodiments, the matrix phase (a) is prepared before the rubber phase (b).

In certain embodiments, the process of the present invention may comprise at least two sequential polymerization stages, with each subsequent polymerization being conducted in the presence of the polymeric material formed in the immediately preceding polymerization reaction, wherein the homo- or copolymerization stage of propylene to the matrix phase (a) is carried out in at least one stage, then at least one subsequent copolymerization stage of mixtures of ethylene with propylene to obtain the rubber phase (b).

All the polymerization stages may be performed in the presence of a stereospecific Ziegler-Natta catalysts. Catalysts having the above-mentioned characteristics are well known in the patent literature, for instance in U.S. Pat. No. 4,399,054, EP-A-45 977 and U.S. Pat. No. 4,472,524.

In some embodiments, the Ziegler-Natta polymerization catalyst comprises:
(i) a solid catalyst component comprising Mg, Ti, an halogen and an internal electron donor compound,
(ii) an alkylaluminum compound, and
(iii) optionally, an external electron-donor compound.

The internal donor is preferably selected from esters of mono- or dicarboxylic organic acids, such as benzoates, malonates, phthalates and succinates and from 1,3-diethers. They are described, for example, in U.S. Pat. No. 4,522,930, EP Pat. Docs. 45977, 361493 and 728769 and WIPO Pat. Nos. WO 00/63261 and WO 01/57099. Alkylphthalates, such as diisobutyl, dioctyl and diphenyl phthalate and benzyl-butyl phthalate, can be used in the present technology. In some embodiments, the internal donor is a succinate.

Ziegler-Natta catalysts for use in the present technology are those containing at least two internal electron donor compounds, the first being present in an amount from 40-90% by mole with respect to the total amount of internal donors and being selected from succinates, and the second being selected from 1,3 diethers. When made with Ziegler-Natta catalysts, the heterophasic propylene copolymers described herein have the additional advantage that the films and sheets produced therefrom do not contain phthalate residues.

Thus, according to one embodiment, the present technology provides for the preparation of a heterophasic propylene copolymer comprising:
(a) from 80% to 92% by weight, including from 82% to 90% by weight, of a matrix phase comprising a propylene homopolymer or a propylene copolymer containing up to 5% by weight of units derived from ethylene and/or an alpha-olefin; and
(b) from 8% to 20% by weight, such as from 10% to 18% by weight, of a rubber phase that is an ethylene-propylene copolymer containing from 20% to 60% by weight of ethylene-derived units;
wherein the overall amount of component (a) and of component (b) is 100% by weight, and
wherein the heterophasic propylene copolymer contains up to 7.0%, including up to 6.5% and up to 6.0% by weight, of ethylene-derived units;
   said process comprising:
(i) a first step of polymerizing propylene in the optional presence of ethylene and/or of an alpha-olefin, to produce a matrix phase (a); and
(ii) a successive step, carried out in the gas-phase, in the presence of the product of step (i), of copolymerizing a mixture of ethylene and propylene to produce a rubber phase (b);
   the process being carried out in the presence of a catalyst system comprising the product obtained by contacting the following components:
(a) a solid catalyst component comprising a magnesium halide, a titanium compound having at least a Ti-halogen bond and at least two electron donor compounds, the first being present in an amount from 40-90% by mole with respect to the total amount of donors and being selected from succinates and the second being selected from 1,3 diethers,
(b) an aluminum hydrocarbyl compound, and
(c) optionally an external electron donor compound.

The succinate may be selected from succinates of the general formula (I):

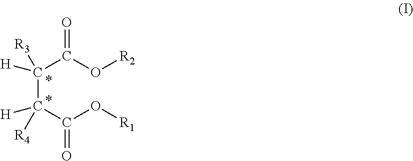

wherein the radicals R1 and R2, equal to or different from each other, are a C1-C20 linear or branched alkyl, alkenyl, cycloalkyl, aryl, arylalkyl or alkylaryl group, optionally containing heteroatoms; and the radicals R3 and R4, equal to or different from each other, are C1-C20 alkyl, C3-C20 cycloalkyl, C5-C20 aryl, arylalkyl or alkylaryl group such that at least one of them is a branched alkyl; said compounds being, with respect to the two asymmetric carbon atoms identified in the structure of formula (I), stereoisomers of the type (S,R) or (R,S). R1 and R2 may be selected from C1-C8 alkyl, cycloalkyl, aryl, arylalkyl and alkylaryl groups. In certain embodiments, R1 and R2 are selected from primary alkyls and branched primary alkyls. Examples of suitable R1 and R2 groups are methyl, ethyl, n-propyl, n-butyl, isobutyl, neopentyl, and 2-ethylhexyl. In further embodiments, the R3 and/or R4 radicals are secondary alkyls like isopropyl, sec-butyl, 2-pentyl, and 3-pentyl or cycloakyls like cyclohexyl, cyclopentyl, and cyclohexylmethyl.

Examples of the above-mentioned compounds are the (S,R) (S,R) forms pure or in mixture, optionally in racemic form, of diethyl 2,3-bis(trimethylsilyl)succinate, diethyl 2,3-bis(2-ethylbutyl)succinate, diethyl 2,3-dibenzylsuccinate, diethyl 2,3-diisopropylsuccinate, diisobutyl 2,3-diisopropylsuccinate, diethyl 2,3-bis(cyclohexylmethyl)succinate, diethyl 2,3-diisobutylsuccinate, diethyl 2,3-dineopentylsuccinate, diethyl 2,3-dicyclopentylsuccinate, diethyl 2,3-dicyclohexylsuccinate.

1,3-diethers for use in the present technology may be selected from compounds of the general formula (II):

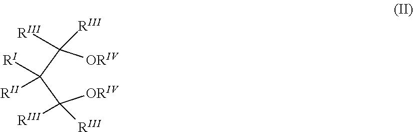

where RI and RII are the same or different and are hydrogen or linear or branched C1-C18 hydrocarbon groups which can also form one or more cyclic structures; the RIII groups, equal to or different from each other, are hydrogen or C1-C18 hydrocarbon groups; the RIV groups equal to or different from each other, have the same meaning of RIII except that they cannot be hydrogen; each of RI to RIV groups can contain heteroatoms selected from halogens, N, O, S and Si. In certain embodiments, RIV is a 1-6 carbon atom alkyl radical such as methyl while the RIII radicals may be hydrogen. Moreover, when RI is methyl, ethyl, propyl, or isopropyl, RII can be ethyl, propyl, isopropyl, butyl, isobutyl, tert-butyl, isopentyl, 2-ethylhexyl, cyclopentyl, cyclohexyl, methylcyclohexyl, phenyl or benzyl; when RI is hydrogen, RII can be ethyl, butyl, sec-butyl, tert-butyl, 2-ethylhexyl, cyclohexylethyl, diphenylmethyl, p-chlorophenyl, 1-naphthyl, 1-decahydronaphthyl; RI and RII can also be the same and can be ethyl, propyl, isopropyl, butyl, isobutyl, tert-butyl, neopentyl, phenyl, benzyl, cyclohexyl, cyclopentyl.

Specific examples of 1,3-diethers that can be advantageously used include: 2-(2-ethylhexyl)1,3-dimethoxypropane, 2-isopropyl-1,3-dimethoxypropane, 2-butyl-1,3-dimethoxypropane, 2-sec-butyl-1,3-dimethoxypropane, 2-cyclohexyl-1,3-dimethoxypropane, 2-phenyl-1,3-dimethoxypropane, 2-tert-butyl-1,3-dimethoxypropane, 2-cumyl-1,3-dimethoxypropane, 2-(2-phenylethyl)-1,3-dimethoxypropane, 2-(2-cyclohexylethyl)-1,3-dimethoxypropane, 2-(p-chlorophenyl)-1,3-dimethoxypropane, 2-(diphenylmethyl)-1,3-dimethoxypropane, 2(1-naphthyl)-1,3-dimethoxypropane, 2(p-fluorophenyl)-1,3-dimethoxypropane, 2(1-decahydronaphthyl)-1,3-dimethoxypropane, 2(p-tert-butylphenyl)-1,3-dimethoxypropane, 2,2-dicyclohexyl-1,3-dimethoxypropane, 2,2-diethyl-1,3-dimethoxypropane, 2,2-dipropyl-1,3-dimethoxypropane, 2,2-dibutyl-1,3-dimethoxypropane, 2,2-diethyl-1,3-diethoxypropane, 2,2-dicyclopentyl-1,3-dimethoxypropane, 2,2-dipropyl-1,3-diethoxypropane, 2,2-dibutyl-1,3-diethoxypropane, 2-methyl-2-ethyl-1,3-dimethoxypropane, 2-methyl-2-propyl-1,3-dimethoxypropane, 2-methyl-2-benzyl-1,3-dimethoxypropane, 2-methyl-2-phenyl-1,3-dimethoxypropane, 2-methyl-2-cyclohexyl-1,3 -dimethoxypropane, 2-methyl-2-methylcyclohexyl-1,3-dimethoxypropane, 2,2-bis(p-chlorophenyl)-1,3-dimethoxypropane, 2,2-bis(2-phenylethyl)-1,3-dimethoxypropane, 2,2-bis(2-cyclohexylethyl)-1,3-dimethoxypropane, 2-methyl-2-isobutyl-1,3-dimethoxypropane, 2-methyl-2-(2-ethylhexyl)-1,3-dimethoxypropane, 2,2-bis(2-ethylhexyl)-1,3-dimethoxypropane,2,2-bis(p-methylphenyl)-1,3-dimethoxypropane, 2-methyl-2-isopropyl-1,3-dimethoxypropane, 2,2-diisobutyl-1,3-dimethoxypropane, 2,2-diphenyl-1,3-dimethoxypropane, 2,2-dibenzyl-1,3-dimethoxypropane, 2-isopropyl-2-cyclopentyl-1,3-dimethoxypropane, 2,2-bis(cyclohexylmethyl)-1,3-dimethoxypropane, 2,2-diisobutyl-1,3-diethoxypropane, 2,2-diisobutyl-1,3-dibutoxypropane, 2-isobutyl-2-isopropyl-1,3-dimetoxypropane, 2,2-di-sec-butyl-1,3-dimetoxypropane, 2,2-di-tert-butyl-1,3-dimethoxypropane, 2,2-dineopentyl-1,3-dimethoxypropane, 2-iso-propyl-2-isopentyl-1,3-dimethoxypropane, 2-phenyl-2-benzyl-1,3-dimetoxypropane, and 2-cyclohexyl-2-cyclohexylmethyl-1,3-dimethoxypropane.

Furthermore, 1,3-diethers of the general formula (III) may be used in accordance with the present technology:

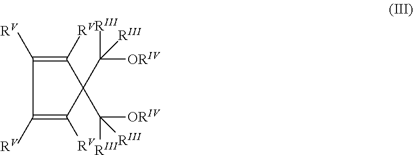

wherein the radicals RIV have the same meaning explained above and the radicals RIII and RV radicals, equal or different to each other, are selected from the group consisting of hydrogen; halogens, such as Cl and F; C1-C20 alkyl radicals, linear or branched; C3-C20 cycloalkyl, C6-C20 aryl, C7-C20 alkaryl and C7-C20 aralkyl radicals and two or more of the RV radicals can be bonded to each other to form condensed cyclic structures, saturated or unsaturated, optionally substituted with RVI radicals selected from the group consisting of halogens, such as Cl and F; C1-C20 alkyl radicals, linear or branched; C3-C20 cycloalkyl, C6-C20 aryl, C7-C20 alkaryl and C7-C20 aralkyl radicals; said radicals RV and RVI optionally containing one or more heteroatoms as substitutes for carbon or hydrogen atoms, or both.

In certain embodiments, in the 1,3-diethers of formulas (I) and (II), all of the RIII radicals are hydrogen, and all of the RIV radicals are methyl. Moreover, the 1,3-diethers of formula (II) in which two or more of the RV radicals are, in some embodiments, bonded to each other to form one or more condensed cyclic structures, such as benzenic, and optionally substituted by RVI radicals. In further embodiments, compounds of the general formula (IV) may be used in accordance with the present technology:

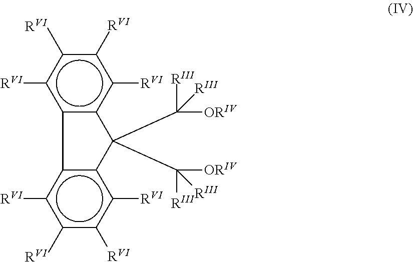

wherein the RVI radicals equal or different are hydrogen; halogens, such as Cl and F; C1-C20 alkyl radicals, linear or branched; C3-C20 cycloalkyl, C6-C20 aryl, C7-C20 alkylaryl and C7-C20 aralkyl radicals, optionally containing one or more heteroatoms selected from the group consisting of N, O, S, P, Si and halogens, including Cl and F, as substitutes for carbon or hydrogen atoms, or both; the radicals RIII and RIV are as defined above for formula (II).

Specific examples of compounds encompassing general formulas (II) and (III) are:
1,1-bis(methoxymethyl)-cyclopentadiene;
1,1-bis(methoxymethyl)-2,3,4,5-tetramethylcyclopentadiene;
1,1-bis(methoxymethyl)-2,3,4,5-tetraphenylcyclopentadiene;
1,1-bis(methoxymethyl)-2,3,4,5-tetrafluorocyclopentadiene;
1,1-bis(methoxymethyl)-3,4-dicyclopentylcyclopentadiene;
1,1-bis(methoxymethyl)indene; 1,1-bis(methoxymethyl)-2,3-dimethylindene;
1,1-bis(methoxymethyl)-4,5,6,7-tetrahydroindene;
1,1-bis(methoxymethyl)-2,3,6,7-tetrafluoroindene;
1,1-bis(methoxymethyl)-4,7-dimethylindene;
1,1-bis(methoxymethyl)-3,6-dimethylindene;
1,1-bis(methoxymethyl)-4-phenylindene;
1,1-bis(methoxymethyl)-4-phenyl-2-methylindene;
1,1-bis(methoxymethyl)-4-cyclohexylindene;
1,1-bis(methoxymethyl)-7-(3,3,3-trifluoropropyl)indene;
1,1-bis(methoxymethyl)-7-trimethyisilylindene;
1,1-bis(methoxymethyl)-7-trifluoromethylindene;
1,1-bis(methoxymethyl)-4,7-dimethyl-4,5,6,7-tetrahydroindene;
1,1-bis(methoxymethyl)-7-methylindene;
1,1-bis(methoxymethyl)-7-cyclopenthylindene;
1,1-bis(methoxymethyl)-7-isopropylindene;
1,1-bis(methoxymethyl)-7-cyclohexylindene;
1,1-bis(methoxymethyl)-7-tert-butylindene;
1,1-bis(methoxymethyl)-7-tert-butyl-2-methylindene;
1,1-bis(methoxymethyl)-7-phenylindene;
1,1-bis(methoxymethyl)-2-phenylindene;
1,1-bis(methoxymethyl)-1H-benz[e]indene;
1,1-bis(methoxymethyl)-1H-2-methylbenz[e]indene;
9,9-bis(methoxymethyl)fluorene;
9,9-bis(methoxymethyl)-2,3,6,7-tetramethylfluorene;
9,9-bis(methoxymethyl)-2,3,4,5,6,7-hexafluorofluorene;
9,9-bis(methoxymethyl)-2,3-benzofluorene;
9,9-bis(methoxymethyl)-2,3,6,7-dibenzofluorene;
9,9-bis(methoxymethyl)-2,7-diisopropylfluorene;
9,9-bis(methoxymethyl)-1,8-dichlorofluorene;
9,9-bis(methoxymethyl)-2,7cyclopentylfluorene;
9,9-bis(methoxymethyl)-1,8-difluorofluorene;
9,9-bis(methoxymethyl)-1,2,3,4-tetrahydrofluorene;
9,9-bis(methoxymethyl)-1,2,3,4,5,6,7,8-octahydrofluorene;
9,9-bis(methoxymethyl)-4-tert-butylfluorene.

As explained above, the catalyst component (a) comprises, in addition to the above electron donors, a titanium compound having at least a Ti-halogen bond and a Mg halide. The magnesium halide may comprise MgCl2 in active form. U.S. Pat. Nos. 4,298,718 and 4,495,338 were the first to describe the use of these compounds in Ziegler-Natta catalysis. It is known from these patents that the magnesium dihalides in active form used as support or co-support in components of catalysts for the polymerization of olefins are characterized by X-ray spectra.

Titanium compounds that may be used in the catalyst component of the present technology are TiCl4 and TiCl3; furthermore, Ti-haloalcoholates of formula Ti(OR)n-yXy can be used, where n is the valence of titanium, y is a number between 1 and n-1 X is halogen and R is a hydrocarbon radical having from 1 to 10 carbon atoms.

In some embodiments, the catalyst component (a) has an average particle size ranging from 15 to 80 μm, such as from 20-70 μm and from 25-65 μm. As previously explained, the succinate is present in an amount ranging from 40-90% by weight with respect to the total amount of donors such as from 50-85% by weight and from 65-80% by weight. In certain embodiments, the 1,3-diether constitutes the remaining amount of electron donor.

In some embodiments, the alkyl-Al compound (b) is chosen from among the trialkyl aluminum compounds such as, for example, triethylaluminum, tri-n-hexylaluminum, and tri-n-octylaluminum. It is also possible to use mixtures of trialkylaluminums with alkylaluminum halides, alkylaluminum hydrides and/or alkylaluminum sesquichlorides such as AlEt₂Cl and Al2Et₃Cl₃.

External electron-donor compounds for use in the present technology include silicon compounds, ethers, esters such as ethyl 4-ethoxybenzoate, amines, heterocyclic compounds such as 2,2,6,6-tetramethyl piperidine, ketones and 1,3-diethers. Another class of external donor compounds is that of silicon compounds of formula Ra5Rb6Si(OR7)c, where a and b are integer from 0 to 2, c is an integer from 1 to 3 and the sum (a+b+c) is 4; R5, R6, and R7, are alkyl, cycloalkyl or aryl radicals with 1-18 carbon atoms optionally containing heteroatoms. In some embodiments, the external electron donor is selected from methylcyclohexyldimethoxysilane, diphenyldimethoxysilane, methyl-t-butyldimethoxysilane, dicyclopentyldimethoxysilane, 2-ethylpiperidinyl-2-t-butyldimethoxysilane, 1,1,1,trifluoropropyl-2-ethylpiperidinyl-dimethoxysilane and 1,1,1,trifluoropropyl-metil-dimethoxysilane. The external electron donor compound is used in such an amount to give a molar ratio between the organo-aluminum compound and the electron donor compound of from 5 to 500, including from 5 to 400 and from 10 to 200.

The catalyst-forming components can be contacted with a liquid inert hydrocarbon solvent such as, e.g. propane, n-hexane or n-heptane, at a temperature below about 60° C., such as from about 0 to 30° C., for a time period of from about 6 seconds to 60 minutes.

The above catalyst components (a), (b) and optionally (c) can be fed to a pre-contacting vessel, in amounts such that the weight ratio (b)/(a) is in the range of 0.1-10 and, if the compound (c) is present, the weight ratio (b)/(c) is weight ratio corresponding to the molar ratio as defined above. In certain embodiments, the components are pre-contacted at a temperature of 10-20° C. for 1-30 minutes. The precontact vessel may be a stirred tank reactor.

The precontacted catalyst is, in certain embodiments, then fed to a prepolymerization reactor where a prepolymerization step takes place. The prepolymerization step can be carried out in a first reactor selected from a loop reactor or a continuously stirred tank reactor, and is generally carried out in liquid-phase. The liquid medium comprises liquid alpha-olefin monomer(s), optionally with the addition of an inert hydrocarbon solvent. The hydrocarbon solvent can be aromatic, such as toluene, or aliphatic, such as propane, hexane, heptane, isobutane, cyclohexane and 2,2,4-trimethylpentane. The amount of hydrocarbon solvent, if any, is lower than 40% by weight with respect to the total amount of alpha-olefins, including lower than 20% by weight. In some embodiments, step (i)a is carried out in the absence of inert hydrocarbon solvents.

The average residence time in this reactor generally ranges from 2 to 40 minutes, such as from 5 to 25 minutes. The temperature ranges between 10° C. and 50° C., such as between 15° C. and 35° C. Adopting these conditions produces a pre-polymerization composition in the range of 60 to 800 g per gram of solid catalyst component, including from 150 to 500 g per gram of solid catalyst component. Step (i)a is further characterized by a low concentration of solid in the slurry, such as in the range from 50 g to 300 g of solid per liter of slurry.

The slurry containing the catalyst, which may be in pre-polymerized form, is fed to a gas-phase or liquid-phase polymerization reactor where component (a) is prepared. In the case of a gas-phase reactor, the reactor may be a fluidized or stirred, fixed bed reactor or a reactor comprising two interconnected polymerization zones, one of which is working under fast fluidization conditions and the other in which the polymer flows under the action of gravity. The liquid phase process can be either in slurry, solution or bulk (liquid monomer). This latter technology can be carried out in various types of reactors such as continuous stirred tank reactors, loop reactors or plug-flow ones. The polymerization is generally carried out at temperature of from 20-120° C., such as from 40-85° C. When the polymerization is carried out in gas-phase, the operating pressure is generally between 0.5 and 10 MPa, such as between 1 and 5 MPa. In the bulk polymerization the operating pressure is generally between 1 and 6 MPa, including between 1.5 and 4 MPa. In certain embodiments, the component (a) is prepared by polymerizing propylene in liquid monomer, optionally in mixture with ethylene and/or an alpha-olefin, in a loop reactor.

In this step and/or in the successive polymerization step, hydrogen can be used as a molecular weight regulator.

The copolymer of component (b) may be produced in a conventional fluidized-bed gas-phase reactor in the presence of the polymeric material and the catalyst system coming from the preceding polymerization step. The polymerization mixture coming from the first polymerization step is discharged to a gas-solid separator, and subsequently fed to the fluidized-bed gas-phase reactor operating under conventional temperature and pressure conditions.

Conventional additives, fillers and pigments, commonly used in olefin polymers, may be added, such as nucleating agents, extension oils, mineral fillers, and other organic and inorganic pigments. The addition of inorganic fillers, such as talc, calcium carbonate and mineral fillers, may improve some mechanical properties, such as flexural modulus and HDT. In some embodiments, talc may be added to produce a nucleating effect.

According to a particular embodiment, a nucleating agent can be added to the heterophasic copolymers for use in the films or sheets of the present technology so to increase the tensile modulus of the heterophasic copolymer.

In certain embodiments, the heat-sealable films described herein may comprise at least one sealing layer. Thus it can be a mono-layer film or a multilayer film, and comprise at least one support layer comprising a polymeric material such as a polyolefin material.

The support layer or layers may comprise one or more polymers or copolymers, or their mixtures, of R—CH═CH₂ olefins, where R is a hydrogen atom or a C1-C6 alkyl radical such as 1-butene, 1-hexene, 1-octene, 4-methyl-1-pentene. In some embodiments, the support layer or layers may comprise the following polymers:
(1) isotactic or mainly isotactic propylene homopolymers;
(2) random copolymers of propylene with ethylene and/or C4-C8 α-olefins, such as for example 1-butene, 1-hexene, 1-octene, 4-methyl-1-pentene, wherein the total comonomer content ranges from 0.05 wt % to 20wt %, or mixtures of copolymers with isotactic or mainly isotactic propylene homopolymers;
(3) heterophasic copolymers comprising (a) a propylene homopolymer and/or one of the copolymers of item (2), and an elastomeric fraction (b) comprising copolymers of ethylene with propylene and/or a C4-C8 α-olefin, optionally containing minor amounts, such as from 1-10% by weight, of a diene such as butadiene, 1,4-hexadiene, 1,5-hexadiene, and ethylidene-1-norbornene.

The heterophasic copolymers (3) can be prepared according to known methods by mixing the components in the molten state, or by sequential copolymerization, and generally contain the copolymer fraction (b) in amounts ranging from 5 to 80% by weight. Heterophasic copolymers according to the present technology can suitably be used in the support layer.

Other olefin polymers employable for the support layers are HDPE, LDPE and LLDPE polyethylenes.

Examples of additional polymeric materials for use as support layers are polystyrenes, polyvinylchlorides, polyamides, polyesters and polycarbonates.

Both the support layers and the heat-sealable layers may comprise additives commonly employed in the art, like stabilizers, pigments, fillers, nucleating agents, slip agents, lubricant and antistatic agents, flame retardants, plasticizers and biocidal agents.

For blown films, the thickness of the layers of heat-sealing composition according to the present technology is, in some embodiments, from 5 to 50 μm, while the thickness of the support layers is, in certain embodiments, from 15 to 130 μm. In further embodiments, the overall thickness of the films is from 20 to 180 μm.

For cast films the thickness of the layers of heat-sealing composition according to the present invention may be from 1 to 100 μm, such as from 5 to 20 μm, while the thickness of the support layers may be from 20 to 200 μm, including from 30 to 100 μm. The overall thickness of the films disclosed herein is, in certain embodiments, from 20 to 300 μm.

Packaging films of the present technology may be produced by using processes known in the art such as extrusion processes. In extrusion processes, the polymer materials to be used for the heat-sealing layers and those to be used for the support layers are molten in different extruders and extruded through a narrow slit. The extruded molten material is pulled away from the slit and cooled before it is wound. Specific examples of extrusion processes are the blown film and cast film processes described herein.

For blown film, the molten polymer materials are forced through a circular shaped slit. The extrudate that is drawn off has the shape of a tube and is inflated by air to form a tubular bubble. The bubble is cooled and collapsed before being wound.

For cast film, the molten polymer materials are forced through a long, thin, rectangular shaped slit. The extrudate has the shape of a thin film. The film is cooled before being wound.

According to still another object, the present technology provides for manufactured articles comprising a film or sheet such as retortable pouches and other containers.

### EXAMPLES

The following examples are given to illustrate the present technology without any limiting purpose.

### Test Methods

### Molar Ratio of Feed Gases

Determined by gas-chromatography.

### Average Particle Size of the Adduct and Catalysts

Determined by a method based on the principle of the optical diffraction of monochromatic laser light with a Malvern Instrument 2600. The average particle size is given as P50.

### Comonomer Content

The content of comonomers was determined by infrared (IR) spectroscopy by collecting the IR spectrum of the sample versus an air background with a Fourier Transform Infrared spectrometer (FTIR). The instrument data acquisition parameters are:
Purge time: 30 seconds minimum
Collection time: 3 minutes minimum
Apodization function: Happ-Genzel
Resolution: 2 cm⁻¹.

Sample Preparation—Using a hydraulic press, a thick sheet is obtained by pressing about 1 g of sample between two aluminum foils. A small portion is cut from this sheet to mold a film. The recommended film thickness ranges between 0.02 and 0.05 cm (8-20 mils). The pressing temperature is 180±10° C. (356° F.) and about 10 kg/cm² (142.2 PSI) of pressure is applied for about one minute. The pressure is released, the sample is removed from the press and cooled to room temperature.

The spectrum of the pressed film sample is recorded in absorbance versus wavenumbers (cm⁻¹). The following measurements are used to calculate ethylene and 1-butene content:
Area (At) of the combination absorption bands between 4482 and 3950 cm⁻¹ which is used for spectrometric normalization of film thickness;
Area (AC2) of the absorption band between 750-700 cm⁻¹ after two proper consecutive spectroscopic subtractions of an isotactic non-additivated polypropylene spectrum and then of a reference spectrum of a 1-butene-propylene random copolymer in the range of 800-690 cm⁻¹;
Height (DC4) of the absorption band at 769 cm⁻¹ (maximum value), after two proper consecutive spectroscopic subtractions of an isotactic non-additivated polypropylene spectrum and a reference spectrum of an ethylene-propylene random copolymer in the range of 800-690 cm⁻¹.

In order to calculate the ethylene and 1-butene content, calibration straight lines for ethylene and 1-butene obtained by using samples of known amount of ethylene and 1-butene were used:

Calibration for ethylene—A calibration straight line is obtained by plotting AC2/At versus ethylene molar percent (% C2m). The slope GC2 is calculated from a linear regression.

Calibration for 1-butene—A calibration straight line is obtained by plotting DC4/At versus butene molar percent (% C4m). The slope GC4 is calculated from a linear regression.

The spectra of the unknown samples are recorded and then (At), (AC2) and (DC4) of the unknown sample are calculated. The ethylene content (% molar fraction C2m) of the sample is calculated as follows:

$$\% C 2 m = \frac{1}{{G}_{C 2}} \cdot \frac{{A}_{C 2}}{{A}_{t}}$$

The 1-butene content (% molar fraction C4m) of the sample is calculated as follows:

$$\% C 4 m = \frac{1}{{G}_{C 2}} \cdot ( \frac{{A}_{C 2}}{{A}_{t}} - {I}_{C 2} )$$

The propylene content (molar fraction C3m) is calculated as follows:

C3m=100−% C4m−% C2m

The ethylene and 1-butene contents by weight are calculated as follows:

$$\% C 2 wt = 100 \cdot \frac{28 \cdot C 2 m}{( 56 \cdot C 4 m + 42 \cdot C 3 m + 28 \cdot C 2 m )}$$

$$\% C 4 wt = 100 \cdot \frac{56 \cdot C 4 m}{( 56 \cdot C 4 m + 42 \cdot C 3 m + 28 \cdot C 2 m )}$$

### Melt Flow Rate (MFR “L”):

Determined according to ISO 1133 (230° C., 2.16 Kg).

Melting Temperature (Tₘ) and Crystallization Temperature (T_{c}):

Both determined by differential scanning calorimetry (DSC) according to the ASTM D 3417 method, which is equivalent to the ISO 11357/1 and 3 method.

### Xylene Solubles (XS):

Determined as follows: 2.5 g of polymer and 250 ml of xylene are introduced in a glass flask equipped with a refrigerator and a magnetic stirrer. The temperature is raised over a time period of 30 minutes up to the boiling point of the solvent. The resulting clear solution is then kept under reflux and stirred for 30 minutes. The (closed) flask is then kept in a thermostatic water bath at 25° C. for 30 minutes. The resulting solid is filtered on quick filtering paper. 100 ml of the filtered liquid is poured in a previously weighed aluminum container, which is heated on a heating plate under nitrogen flow to remove the solvent by evaporation. The container is then kept on an oven at 80° C. under vacuum until a constant weight is obtained. The weight percentage of polymer soluble in xylene at room temperature is then calculated.

### Intrinsic Viscosity (IV):

Determined in tetrahydronaphthalene at 135° C.

### Tensile Modulus (MET):

Determined according to ISO 527-1, -2 (1 mm/min).

### Charpy Impact Strength:

Determined according to ISO 179-1, 2010 (Type 1, Edgewise, Notch A).

### Ductile Brittle Transition Temperature (DB/TT):

The bi-axial impact resistance is determined through impact with an automatic, computerized striking hammer. The circular test specimens are obtained by cutting with a circular hand punch (38 mm diameter) to produce plaques as described below. The circular test specimens are conditioned for at least 12 hours at 23° C. and 50 RH and then placed in a thermostatic bath at the testing temperature for 1 hour. The force-time curve is detected during impact of a striking hammer (5.3 kg, hemispheric punch with a ½″ diameter) on a circular specimen resting on a ring support. The machine used is a CEAST 6758/000 Model No. 2. The DB/TT is the temperature at which 50% of the samples undergoes fragile breaking when submitted to the above-mentioned impact test. The plaques for DB/TT measurements, having dimensions of 127×127×1.5 mm are prepared according to the following method. The injection press is a Negri Bossi™ NB 90 with a clamping force of 90 tons. The mold is a rectangular plaque (127×127×1.5 mm). The main process parameters are reported below:
Back pressure: 20 bar
Injection time: 3 sec
Maximum Injection pressure: 14 MPa
Hydraulic injection pressure: 6−3 MPa
First holding hydraulic pressure: 4±2 MPa
First holding time: 3 sec
Second holding hydraulic pressure: 3±2 MPa
Second holding time: 7 sec
Cooling time: 20 sec
Mold temperature: 60° C.
Melt temperature 220-280° C.

### Seal Strength:

Measured by using a Brugger HSG/ETK sealer with a 10 mm Teflon-coated sealing bar at 4 bar of pressure, a 190° C. temperature and a 1.0 second dwell time. The cast film specimen to be sealed has a thickness of 70 micron. The sealing is carried out on the chill roll side. The heat-sealed film specimen is sterilized at 135° C. for 45 min in a Systec DX-65 autoclave and left in the autoclave until the specimen reaches room temperature. Then it is kept at 23° C. and 50% relative humidity for at least 12 hours. The seal strength is measured using an Instron Model 5565A tensile tester. The clamps distance is 30 mm, and the crosshead speed is 100 mm/min. The specimen width is 15 mm. The force at yield measured during the tensile test is defined as the seal strength.

### Examples 1C (Comparative) and 2-4

### Preparation of the Solid Catalyst Component:

Into a 500 mL four-necked round flask, purged with nitrogen, 250 mL of TiCl₄ were introduced at 0° C. While stirring, 10.0 g of microspheroidal MgCl₂.2.1C₂H₅OH having an average particle size of 47 μm (prepared in accordance with the method described in Example 1 of EP728769) and an amount of diethyl 2,3-diisopropylsuccinate such as to have a Mg/succinate molar ratio of 15 were added. The temperature was raised to 100° C. and kept at this value for 60 minutes. The stirring was stopped and the liquid was siphoned off. After siphoning, fresh TiCl₄ and an amount of 9,9-bis(methoxymethyl)fluorene such as to have a Mg/diether molar ratio of 30 were added. Then the temperature was raised to 110° C. and kept for 30 minutes under stirring. After sedimentation and siphoning at 85° C., fresh TiCl₄ was added. Then the temperature was raised to 90° C. for 15 min. After sedimentation and siphoning at 90° C. the solid was washed three times with anhydrous hexane (3×100 ml) at 60° C. and additional three times with anhydrous hexane (3×100 ml) at 25° C. The resulting solid catalyst component had a total amount of internal electron donor compounds of 12.0% by weight with respect to the weight of the solid catalyst component.

### Preparation of the Catalyst System—Precontact

Before introducing it into the polymerization reactors, the solid catalyst component described above is contacted with aluminum-triethyl (TEAL) and with the donor indicated in Table 1 under the conditions reported therein.

### Prepolymerization

The catalyst system is then subject to prepolymerization treatment at 20° C. by maintaining it in suspension in liquid propylene for a residence time of 8 minutes before introducing it into the polymerization reactor.

### Polymerization

The polymerization was carried out in continuous mode in two reactors in series: a first liquid phase loop reactor, operated at a temperature of 75° C. and a pressure of 41 barg, and a second gas phase polymerization reactor operated at a temperature of 80° C. and a pressure of 11-12 barg. Hydrogen was used as the molecular weight regulator. The polymer particles exiting from the polymerization step were subjected to a steam treatment to remove the unreacted monomers and dried under a nitrogen flow.

Process conditions are reported in Table 1. Characterization data for the obtained polymers are reported in Table 2.

The polymer particles were blended in a Werner 58 extruder with the following additives:
Calcium stearate—0.065% wt
IRGAFOS® 168—0.065% wt
IRGANOX® 1010—0.065% wt
   Characterization data for the resulting compositions are reported in Table 3.

### Preparation of Film Specimens:

Cast films were prepared by extruding each test composition in a single screw Dr. Collin cast film extruder equipped with a three layers co-extrusion cast film line (main extruder screw diameter 45 mm, L/D 30; two side extruders screw diameter 30 mm, L/D 30), at a melt temperature of 190-250° C. The throughput was about 18.5 kg/h. The cast film has been winded at a film drawing speed between 12 and 13 m/min with a thickness of 70 micron.

### Examples 5C (Comparative) and 6

Performed according to the procedure described in examples 1-4, except that the solid catalyst component was prepared as described as in Examples 1-3 of WIPO PCT App. Pub. No. WO2009/050045. Process conditions and characterization data of the polymers, pellets and film are reported in Tables 1-3.

### Example 7

Part of the polymer particles obtained in Example 2 were blended in a Werner 58 extruder with the following additives (all percentages by weight):
Calcium stearate—0.065%
IRGAFOS® 168—0.065%
IRGANOX® 1010—0.065%
Hyperform® HPN-20E—0.0270%
   Process conditions and characterization data of the polymers, pellets and film obtained therefrom are reported in Tables 1-3.

TABLE 1
Process conditions

| Example | | | | | |
|---|---|---|---|---|---|
| 1C | 2C | 3 | 4C | 5C | 6C |

Precontact

| | | | | | | |
|---|---|---|---|---|---|---|
| Temperature (° C.) | 12 | 12 | 14 | 14 | 14 | 14 |
| Residence time (min) | 25 | 25 | 20 | 19 | 21 | 23 |
| TEAL/donor ratio (wt) | 10 | 8.6 | 4.4 | 4 | 5.5 | 6 |
| Donor type | C | C | D | D | D | D |

Loop 1^{st} reactor in liquid phase - propylene homopolymerization

| | | | | | | |
|---|---|---|---|---|---|---|
| Residence time (min) | 92 | 89 | 96 | 85 | 79 | 81 |
| H₂ feed (ppm) | 517 | 420 | 450 | 940 | 1100 | 960 |

Gas-Phase reactor - ethylene/propylene copolymerization

| | | | | | | |
|---|---|---|---|---|---|---|
| Pressure (barg) | 11 | 11 | 11 | 12 | 12 | 12 |
| Residence time (min) | 20 | 26 | 12 | 35 | 20 | 30 |
| C₂⁻/C₂⁻ + C₃⁻ (mol_ratio) | 0.31 | 0.16 | 0.30 | 0.15 | 0.32 | 0.17 |
| H₂/C₂⁻ (mol_ratio) | 0.028 | 0.025 | 0.040 | 0.034 | 0.06 | 0.051 |

Notes:
C₂⁻ = ethylene;
C₃⁻ = propylene;
H₂ = hydrogen;
C = cyclohexyl-methyl-di-methoxy-silane;
D = di-cyclopentyl-di-methoxy-silane

TABLE 2
Polymer characterization

| Example | | | | | |
|---|---|---|---|---|---|
| 1C | 2C | 3 | 4C | 5C | 6C |

Matrix phase (a)

| | | | | | | | |
|---|---|---|---|---|---|---|---|
| Amount | % | 81 | 83 | 82 | 85 | 82 | 82 |
| MFR “L” | g/10′ | 0.9 | 0.9 | 0.8 | 0.8 | 0.7 | 0.8 |
| XSa | wt % | 2.3 | 2.4 | 2.0 | 2.1 | 1.8 | 1.8 |

Rubber phase (b)

| | | | | | | | |
|---|---|---|---|---|---|---|---|
| Amount | % | 19 | 17 | 12 | 15 | 18 | 17 |
| MFR “L” | g/10′ | 0.7 | 0.7 | 0.8 | 0.7 | 0.7 | 0.6 |
| Ethylene units (*) | % | 43 | 31 | 43 | 31 | 42 | 32 |

Heterophasic copolymer

| | | | | | | | |
|---|---|---|---|---|---|---|---|
| Ethylene units | % | 8.2 | 5.3 | 5.2 | 4.7 | 7.6 | 5.4 |
| XS | wt % | 18.3 | 17.0 | 12.3 | 15.2 | 17.4 | 16.5 |
| XSIV | dl/g | 2.85 | 2.89 | 2.85 | 2.85 | 2.61 | 2.9 |

(*) = calculated

TABLE 3
Pellets and film characterization

| Example | | | | | | |
|---|---|---|---|---|---|---|
| 1C | 2C | 3 | 4C | 5C | 6C | 7C |

Pellets

| | | | | | | | | |
|---|---|---|---|---|---|---|---|---|
| MFR “L” | g/10′ | 0.8 | 1.1 | 0.8 | 0.8 | 0.7 | 0.6 | 0.8 |
| MET 48 h | MPa | 1040 | 970 | 1280 | 990 | 1060 | 1030 | 1030 |
| Charpy −20° C. 48 h | kJ/m² | 7.6 | 4.0 | 6.5 | 6.6 | 8.5 | 6.7 | 8.1 |
| DB/TT | ° C. | −45.6 | n/a | −25.5 | −15.5 | −38.3 | −23.6 | −25.8 |
| Tₘ | ° C. | 162.6 | 163.1 | 162.6 | 162.3 | 164.2 | 163.5 | 163.1 |
| T_{c} | ° C. | 107.7 | 109.7 | 108.7 | 108.5 | 114.2 | 112.6 | 118.9 |

Film

| | | | | | | | | |
|---|---|---|---|---|---|---|---|---|
| Seal strenght | N | 25.3 | 28.1 | 28.6 | 28.2 | 21.7 | 29.9 | 28.1 |

n/a = not available

What is claimed is:

1. A film or sheet of at least one layer comprising a heterophasic propylene copolymer comprising:
(a) 85%-92% by weight of a matrix phase comprising a propylene homopolymer or a propylene copolymer containing up to 5% by weight of units derived from ethylene and/or an alpha-olefin; and
(b) 8%-15% by weight of a rubber phase comprising an ethylene-propylene copolymer containing from 40% to 60% by weight of ethylene-derived units;
wherein the overall amount of component (a) and of component (b) is 100% by weight, and
wherein the heterophasic propylene copolymer contains up to 6.0% by weight of ethylene-derived units.

2. The film or sheet of claim 1, wherein the amount of rubber phase is lower than 14%.

3. The film or sheet of claim 1, wherein the rubber phase is an ethylene-propylene copolymer containing from 40%-50%, by weight of ethylene-derived units.

4. The film or sheet of claim 1, wherein the heterophasic propylene copolymer comprises a nucleating agent.

5. A process for the preparation of a heterophasic propylene copolymer comprising:
(a) 80%-92% by weight of a matrix phase comprising a propylene homopolymer or a propylene copolymer containing up to 5% by weight of units derived from ethylene and/or an alpha-olefin; and
(b) 8%-20% by weight of a rubber phase comprising an ethylene-propylene copolymer containing from 20%-60% by weight of ethylene-derived units;
wherein the overall amount of component (a) and of component (b) is 100% by weight, and
wherein the heterophasic propylene copolymer contains up to 7.0% by weight of ethylene-derived units.
said process comprising:
a first step of polymerizing propylene in the optional presence of ethylene and/or of an alpha-olefin, to produce a matrix phase (a); and
(ii) a successive step, carried out in the gas-phase, in the presence of the product coming from step (i), of copolymerizing a mixture of ethylene and propylene to produce a rubber phase (b);
the process being carried out in the presence of a catalyst system comprising the product obtained by contacting the following components:
(a) a solid catalyst component comprising a magnesium halide, a titanium compound having at least a Ti-halogen bond and at least two electron donor compounds, the first electron donor being present in an amount from 40 to 90% by mole with respect to the total amount of donors and being selected from succinates and the second electron donor being selected from 1,3 diethers,
(b) an aluminum hydrocarbyl compound, and
(c) optionally an external electron donor compound.

6. A manufactured article comprising the film or sheet of claim 1.

7. The manufactured article of claim 7, comprising a retortable packaging item.
